(19) United States
(12) Patent Application Publication
(10) Pub. No.: US 2021/0112966 A1
(43) Pub. Date: Apr. 22, 2021

(54) PUSH BROOM WITH ATTACHED SCRAPER DEVICE

(71) Applicant: Donald Buchanan, Charleston, SC (US)

(72) Inventor: Donald Buchanan, Charleston, SC (US)

(21) Appl. No.: 16/654,002

(22) Filed: Oct. 16, 2019

(51) Int. Cl. A46B 15/00; A47L 13/08; B25G 3/02

(52) U.S. Cl. CPC A46B 15/0081; A46B 2200/302; B25G 3/02; A47L 13/08

(57) ABSTRACT

A push broom with attached scraper device including a push broom member and a scraper member. The push broom member includes a handle element and a head element. The head element has an aperture on a top region of the head element for receiving the handle element which is secured to the head element with a first mechanical mechanism and has a plurality of bristles on a bottom region of the head element. The scraper member includes a scraper blade which is fixedly attached to the top region of the head element of the push broom member and the scraper blade is secured to the head element with a second mechanical mechanism.

### FIELD OF THE INVENTION

Embodiments described herein generally relate to push brooms, and more particularly to a push broom including an attached scraper.

### BACKGROUND OF THE INVENTION

Storms and rain will always leave porches and sidewalks dirty or covered with a thin layer of compacted mud. Traditionally, to clean these surfaces, at least two tools are needed: one to brush off the dust and/or debris and another tool to scrape off ice and/or mud. It would be more efficient to use a tool that is capable of performing both of brushing off dust and debris and scraping off ice and mud. Hence, an improved tool is desired for performing both brushing and scraping.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary view of a push broom with attached scraper device according to an embodiment of the present disclosure.

### SUMMARY OF THE INVENTION

Exemplary embodiments disclosed herein describe a push broom with attached scraper device including a push broom member and a scraper member. The push broom member includes a handle element and a head element. The head element has an aperture on a top region of the head element for receiving the handle element which is secured to the head element with a first mechanical mechanism and has a plurality of bristles on a bottom region of the head element. The scraper member includes a scraper blade which is fixedly attached to the top region of the head element of the push broom member, the scraper blade is secured to the head element with a second mechanical mechanism.

In some exemplary embodiments, the scraper blade is attached to the head element at a forty-five degree angle.

In some exemplary embodiments, the push broom member is oriented for use when the bristles attached to the head element come into contact with a ground surface.

In some exemplary embodiments, the scraper member is oriented for use when a distal end of the scraper blade comes into contact with a ground surface.

In some exemplary embodiments, the first mechanical mechanism includes a plurality of hex-head screws.

In some exemplary embodiments, the second mechanical mechanism includes a plurality of connectors.

### DETAILED DESCRIPTION

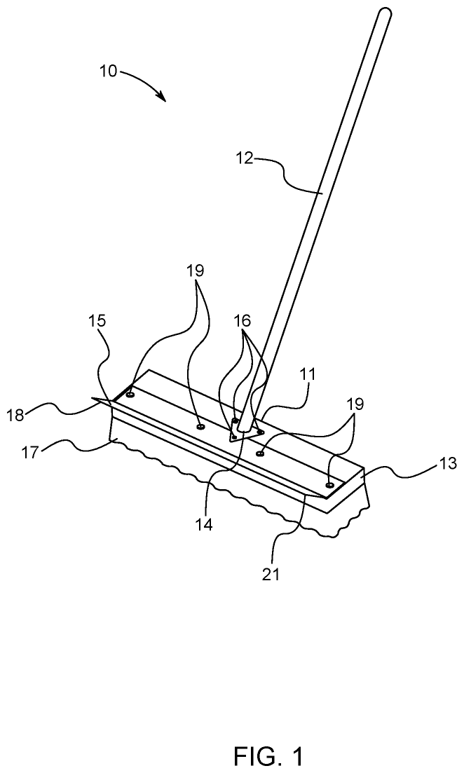

The present disclosure relates to a dual purpose tool which may be used to clean a flat surface which may require brushing and scraping for adequate cleaning. The tool is a push broom with attached scraper device (“the device”). As illustrated in FIG. 1, the device 10 includes a push broom member 11 and a scraper member 15. The push broom member 11 may be used to sweep/brush up dirt, dust, and debris from a surface. The scraper member 15 may be used to scrape off contents that may not be easily swept up with a broom, such as, for example, ice, mud, etc.

The push broom member 11 includes a handle element 12, and a head element 13. The head element includes an aperture 14 for receiving the handle element 12. The handle member is secured to the member head element with a first mechanical mechanism 16. The handle member made be made out of any suitable material, such as, for example, wood. The mechanical mechanism may include any suitable hardware connectors or fasteners. In a preferred embodiment, the first mechanical mechanism includes a plurality of hex-head screws and machine screw insets in the top region of the head element 13. The head element 13 includes a plurality of bristles 17 at a bottom region of head element. The bristles may be flagged or unflagged. The bristles may be made out of any suitable material.

The scraper member 15 includes a scraper blade 18 which is fixedly attached to the top region of the head element 13. The scraper blade 18 may be made out of any suitable material, such as, for example, metal. The scraper blade may be attached to the head element at a suitable angle. In a preferred embodiment, the scraper blade is attached to the head element 13 at a forty-five (45) degree angle. The scraper blade is secured to the head element 13 with a second mechanical mechanism. The mechanical mechanism may include any suitable hardware connectors or fasteners. In a preferred embodiment, the second mechanical mechanism includes a plurality of connectors.

In operation, the push broom member 11 is oriented for use (as shown in FIG. 1) when the bristles 17 attached to the head element 13 come into contact with a ground surface. The scraper member 15 is oriented for use when a distal end 21 of the scraper blade 18 comes into contact with a ground surface. The device 10 may be flipped/turned over such that the bristles 17 are no longer touching a ground surface so that the scraper blade 18 may come into contact with the ground surface.

The bristles 17 and the scraper blade 18 may easily be cleaned after use, preventing scraped off contents from building up and damaging the effectiveness of the device 10. The device may be easily stored in a closet or a workspace. The device 10 may be used indoors or outdoors.

In some exemplary embodiments, the head element, the handle and the scraper blade may be replaceable.

The disclosed embodiments are not inclusive and many other modifications and variations will be apparent to someone of ordinary skill in the art with construction skills in the related arts. Together the descriptions and accompanying illustrations seek to provide an explanation of the basic principles of the embodiment and its application. It is therefore intended that the specification and embodiments be considered as exemplary only.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A push broom with attached scraper device comprising:
a push broom member including a handle element and a head element having an aperture on a top region of the head element for receiving the handle element which is secured to the head element with a first mechanical mechanism and having a plurality of bristles on a bottom region of the head element; and
a scraper member including a scraper blade which is fixedly attached to the top region of the head element of the push broom member, the scraper blade is secured to the head element with a second mechanical mechanism.

2. The device of claim 1, wherein the scraper blade is attached to the head element at a forty-five degree angle.

3. The device of claim 1, wherein the push broom member is oriented for use when the plurality of bristles attached to the head element come into contact with a ground surface.

4. The device of claim 1, wherein the scraper member is oriented for use when a distal end of the scraper blade comes into contact with a ground surface.

5. The device of claim 1, wherein the first mechanical mechanism includes a plurality of hex-head screws.

6. The device of claim 1, wherein the second mechanical mechanism includes a plurality of connectors.
